(19) United States
(12) Patent Application Publication
(10) Pub. No.: US 2021/0325188 A1
(43) Pub. Date: Oct. 21, 2021

(54) METHOD AND A SYSTEM FOR GUIDING A USER THROUGH A SAFE EXIT PATH

(71) Applicant: Carrier Corporation, Palm Beach Gardens, FL (US)

(72) Inventors: Avineet Nanda, Hyderabad (IN); Nadeem Shaikh, Hyderabad (IN); Ramesh Lingala, Hyderabad (IN)

(21) Appl. No.: 17/115,353

(22) Filed: Dec. 8, 2020

(30) Foreign Application Priority Data
Apr. 20, 2020 (IN) 202011016915

(51) Int. Cl. G01C 21/20; G06F 16/29; A62C 99/00; H04W 4/024

(52) U.S. Cl. CPC G01C 21/206; H04W 4/024; A62C 99/00; G06F 16/29

(57) ABSTRACT

A system and a method for guiding a user through a safe exit path on an occurrence of a fire event in a premises. A method includes receiving instructions related to a fire event inside a premise from an access control database. Also, the access control database receives information related to the fire event from a fire control panel. The access control determines one or more safe exit paths based on the information related to the fire event. The method further includes selecting a safe exit path from the one or more safe exit paths and guiding a user of a mobile device through the safe exit path using augmented reality.

### FOREIGN PRIORITY

This application claims priority to Indian Patent Application No. 202011016915, filed Apr. 20, 2020, and all the benefits accruing therefrom under 35 U.S.C. § 119, the contents of which in its entirety are herein incorporated by reference.

### TECHNICAL FIELD

The present invention generally relates to fire safety systems. More particularly, the invention relates to a system, a device and a method for guiding a user through a safe exit path on an occurrence of a fire event in a premises.

### BACKGROUND

During any fire/smoke breakouts or in an emergency situation in a building/premise, it may be difficult for occupants present inside the building to locate a nearest fire exit path or a specific assembly point. This could be due to improper fire exit signages in the building, poor visibility due to the fire/smoke, unfamiliarity with the building, or unavailability of emergency response team (ERT) volunteers and staff personnel etc. In the event of a fire, occupants present inside the building vacate it as soon as possible. To vacate the building, occupants mostly use exit path/s (such as stairs) provided in the building to escape the fire/smoke. In particular, the occupants may use a shortest or closest exit path to come out of the building. Further, during the fire event or the emergency situation, each and every second is very important for the occupants to evacuate to safe zones by identifying a nearest fire exit path because longest paths may slowdown the entire evacuation process and would result in the occupants stuck in the fire.

However, when occupants take any closest random exit paths to come out of the building, they may not know about an actual or a real-time status of such an exit path in the event of a fire/smoke. Also, occupants may not know if the fire/smoke has entered the exit paths and are safe to use or not. When unsafe exit paths are used by occupants, it poses a huge risk to them as they may suffocate/burn in the presence of fire/smoke present in these paths.

In view of the afore-mentioned problems, there is a need of an efficient and effective system and a method for preventing occupants from taking an exit path where fire/smoke has already entered or is present. There is also a need to provide a solution for informing occupants about one or more safe exit paths which is safe to use during a fire event. In order to solve the problems in the existing solutions, a system, a device and a method are disclosed.

### SUMMARY

Various embodiments of the invention describe a system for guiding a user through a safe exit path on an occurrence of a fire event in a premises. The system comprises a fire control panel, an access control database and a mobile device. The fire control panel is configured to detect a fire event inside a premise and transmit information related to the fire event. Further, the access control database is configured to receive the information related to the fire event and determine one or more safe exit paths based on the information related to the fire event. The access control database is also configured to transmit instructions related to the fire event. The instructions comprise the one or more safe exit paths. The mobile device is configured to receive the instructions related to the fire event and select a safe exit path from the one or more safe exit paths and guide a user of the mobile device through the safe exit path using augmented reality.

In an embodiment of the invention, the fire control panel is configured to detect the fire event using one or more fire detectors installed inside the premise and confirm the fire event before transmitting the fire event information to the access control database.

In a different embodiment of the invention, the fire event information is transmitted to the access control database using a Wi-Fi network, a cellular network or a bluetooth mesh network.

In an embodiment of the invention, the fire event information comprises a location of the fire event and/or fire intensity of the fire event.

In another embodiment of the invention, the access control database comprises a digitized map and/or entry and exit paths information of the premises. Also, the access control database is configured to determine the one or more safe exit paths based on the fire event information using the digitized map and/or the entry and exit paths information of the premises.

In yet another embodiment of the invention, the mobile device is configured to execute a user application. The user application is executed to guide the user of the mobile device through the safe exit path.

In another embodiment of the invention, the mobile device uses an audio unit and a visual unit of the mobile device to guide the user of the mobile device through the safe exit path using augmented reality.

In still another embodiment of the invention, the access control database transmits the instructions related to the fire event to the mobile device through a Wi-Fi network, a cellular network or a bluetooth mesh network.

In a different embodiment of the invention, the access control database is communicably connected to a plurality of accessing devices inside the premise. In case of the fire event, the access control database transmits the instructions related to the fire event to the plurality of accessing devices. Also, each of the accessing devices open automatically on receiving the instructions.

In yet another embodiment of the invention, the mobile device is configured to receive the instructions related to the fire event from an accessing device of the plurality of accessing devices.

In another embodiment of the invention, the mobile device uses ultra-wide band technology to guide the user of the mobile device through the safe exit path. Also, the mobile device instructs the user using the ultra-wide band technology in case the user moves to an incorrect path.

In an embodiment of the invention, each of the accessing devices is configured to show direction of the safe exit path on receiving the instructions related to the fire event from the access control database.

Other various embodiments of the invention describe a mobile device comprising a receiving unit configured to receive instructions related to a fire event inside a premise from an access control database. The access control database is configured to receive information related to the fire event from a fire control panel and determine the instructions related to the fire event based on the information related to the fire event. The instructions comprise one or more safe exit paths. The mobile device also comprises a processing unit configured to select a safe exit path from the one or more safe exit paths and an audio/visual unit configured to guide a user of the mobile device through the safe exit path using augmented reality.

In an embodiment of the invention, the mobile device is configured to execute a user application. The user application is executed to guide the user of the mobile device through the safe exit path.

In a different embodiment of the invention, the access control database is communicably connected to a plurality of accessing devices inside the premises. In case of the fire event, the access control database transmits the instructions related to the fire event to the plurality of accessing devices. The accessing devices open automatically on receiving the instructions.

In yet another embodiment of the invention, the mobile device is configured to receive the instructions related to the fire event from an accessing device of the plurality of accessing devices.

In an embodiment of the invention, the accessing devices are configured to show the direction of the safe exit path on receiving the instructions related to the fire event from the access control database.

In another embodiment of the invention, the mobile device uses ultra-wide band technology to guide the user of the mobile device through the safe exit path. The mobile device also instructs the user using the ultra-wide band technology in case the user moves to an incorrect path.

Various embodiments of the invention describe a method for guiding a user through a safe exit path on an occurrence of a fire event in a premises. The method comprises steps of receiving instructions related to a fire event inside a premise from an access control database. Further, the access control database receives information related to the fire event from a fire control panel and determines one or more safe exit paths based on the information related to the fire event. The method further comprises steps of selecting a safe exit path from the one or more safe exit paths and guiding a user of a mobile device through the safe exit path using augmented reality.

In another different embodiment of the invention, a computer readable medium is disclosed for guiding a user through a safe exit path on an occurrence of a fire event in a premises. The computer readable medium comprises one or more processors and a memory is coupled to the one or more processors, the memory stores instructions executed by the one or more processors. The one or more processors are configured to receive instructions related to a fire event inside a premise from an access control database. Also, the access control database receives information related to the fire event from a fire control panel and determines one or more safe exit paths based on the information related to the fire event. The one or more processors are further configured to select a safe exit path from the one or more safe exit paths and guide a user of a mobile device through the safe exit path using augmented reality.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1A depicts an exemplary system architecture with fire event at a location in a premises according to an exemplary embodiment of the invention.

FIG. 1B depicts an exemplary system architecture with fire event at a different location in a premises according to an exemplary embodiment of the invention.

FIGS. 1C-1D depict an exemplary mobile device guiding a user through a safe exit path using augmented reality according to an exemplary alternative embodiment of the invention.

FIG. 2 depicts block diagram of different components of an exemplary mobile device according to an exemplary embodiment of the invention.

FIG. 3 depicts an exemplary flowchart illustrating a method to perform the invention according to an exemplary embodiment of the invention.

Corresponding reference numerals indicate corresponding parts throughout the drawings.

### DETAILED DESCRIPTION

Described herein is the technology with a system, a device and a method for guiding a user through a safe exit path on an occurrence of a fire event in a premises. A user may be present inside a building/premises when a fire event emerges inside the premises. The premises may have a fire control panel communicably coupled with a plurality of fire detectors to detect the fire event in the premises. The fire control panel may determine and transmit information related to the fire event to an access control database through a network. The information related to the fire event may comprise fire intensity reading, a unique identifier of a fire detector, location of a fire detector and/or a location of the fire event. Based on the information related to the fire event, the access control database may determine one or more safe exit paths. In order to determine the one or more safe exit paths, the access control database may use a digitized map and/or entry and exit paths information of the premises.

Further, the access control database may transmit instructions related to the fire event to a mobile device of a user through a network. Such instructions transmitted to the access control database may comprise one or more safe exit paths present in the premises. The user of the mobile device may be present inside the premises. The mobile device may select a safe exit path from the one or more safe exit paths and guide the user of the mobile device through the safe exit path using augmented reality. In an exemplary embodiment, the mobile device may provide voice guidance and/or display direction/s for the safe exit path using a camera of the mobile device from a location of the user to show the user a correct/safe path. Specifically, the direction/s such as turn right, turn left or go straight may be superimposed on a visual stream of the premises (for example, safe exit paths) being captured by the camera. This would help and guide the user to exit the premises using the safe exit path.

In an alternative embodiment, the access control database may transmit the instructions comprising the one or more safe exit paths to a plurality of accessing devices installed at a door of each room of the premises. The access control database and the plurality of accessing devices may be communicably connected with each other through a network. As a result, the mobile device may receive the instructions comprising the one or more safe exit paths from the plurality of accessing devices instead of the access control database. This would enable each of plurality of accessing devices to display directions to the user for guiding the user to exit the premises. In addition, on receiving the instructions, the plurality of accessing devices may automatically open or gets unlock so that the user exit from the room of the premises.

As used herein, the plurality of fire detectors and/or the fire control panel are capable of detecting fire event inside the premises. The plurality of fire detectors may be communicably connected with the plurality of fire control panel through a network. Further, the fire control panel may be communicably connected with an access control database through a network. Few examples of the plurality of fire detectors may include, but is not limited to, an ionization smoke detector, a photoelectric or an optical smoke detector, an aspirating smoke detector (ASD), optical flame detectors or any such detectors that is well known in the art.

As used herein, the plurality of accessing devices may refer to locks that may be installed on a door of each room present inside the premises. Such locks may be electronic locks which can be accessed using a mobile device, physical keys or a physical access card. Also, the plurality of accessing devices may be communicably coupled with the mobile device and/or the access control database through a network. The plurality of accessing devices may comprise, but is not limited to, a transceiver, an interface, a battery, a processor and/or a memory.

As used herein, the premises may be a building, home, bank, office, mall, college, hospital and/or or any such premises having a plurality of exit paths where a fire event may occur and one or more users are present inside the premises. Further, the one or more fire detectors, the fire control panel, and the plurality of accessing devices may also be located or positioned/installed inside the premises.

As used herein, the access control database may be a server having processing capabilities as disclosed further in the specification. The access control database may be a cloud storage, a remote database, or any such storage known in the art.

As used herein, the mobile device may refer to a hand-held device such as a smartphone with internet connectivity. The internet connectivity may be provided to the mobile device through a network. The mobile device may include, but is not limited to, a desktop, a laptop, a smart phone, a tablet, a personal digital assistance, a wearable device, or any such mobile device that is obvious to a person skilled in the art.

As used herein, the network may refer to a wired network, a mesh network, a cellular network (such as Global System for Mobile (GSM) network, a Long-Term Evolution (LTE) network, a code-division multiple access (CDMA) network, a narrow-band internet of thing (NB-IoT) technique or category M1 technique)), a short-range network (a bluetooth network, a WiFi network, or a ZigBee network) or any such network/technique that is known in the art.

Throughout the specification, reference numeral 104 depicts all rooms. Each of the reference numerals 104A-104D may be considered as a separate room. Likewise, throughout the specification, reference numeral 106 depicts all accessing devices. Each of the reference numerals 106A-106D may be considered as a separate accessing device. Also, throughout the specification, reference numeral 108 depicts all fire detectors. Each of the reference numerals 108A-108D may be considered as a separate fire detectors.

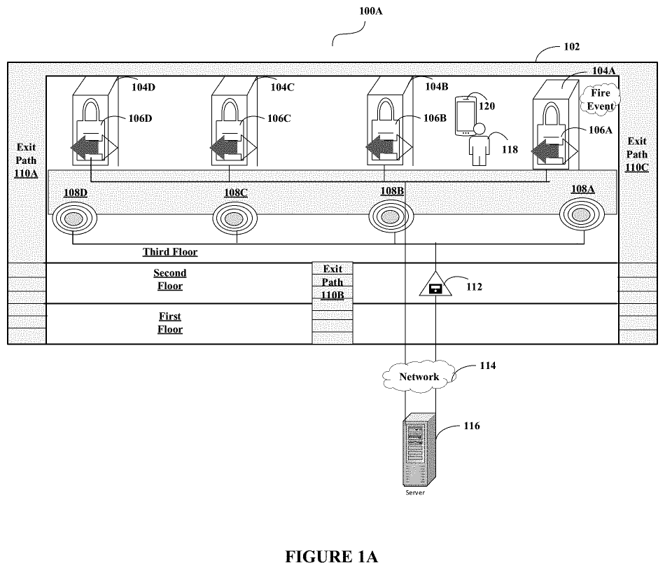

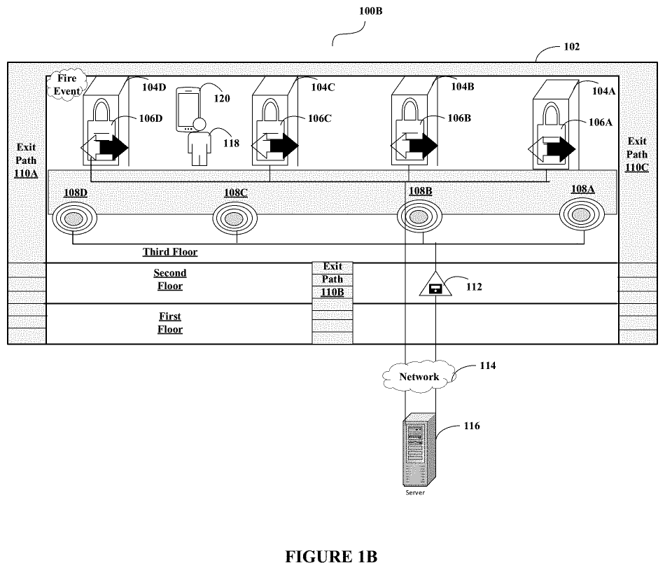

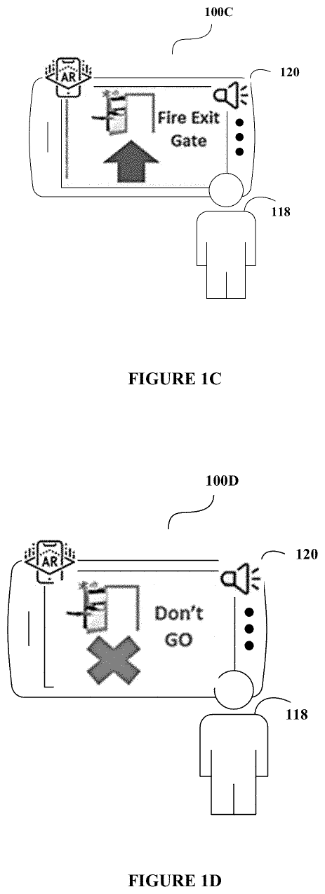

FIG. 1A depicts an exemplary system architecture 100A disclosing a fire event which occurred at a location in a premises according to an exemplary embodiment of the invention. As depicted in FIG. 1A, a premises 102 may have a plurality of floors, namely a first floor, a second floor and a third floor. Each of the floor in the premises may have a plurality of rooms 104 with a plurality of accessing devices 106. For an instance, at the third floor of the premises 102, a first accessing device 106A may be installed at a door of a first room 104A, a second accessing device 106B may be positioned/installed at a door of a second room 104B, a third accessing device 106C may be installed at a door of a third room 104C, and a fourth accessing device 106D may be installed at a door of a fourth room 104D. Moreover, at the third floor, a plurality of fire detectors 108A-108D may also be installed. In this example, there are four fire detectors 108A-108D installed at various places in the third floor. In addition, the premises 102 may have a plurality of exit paths 110, namely a first exit path 110A, a second exit path 110B and a third exit path 110C. In the same way, at each floor, several fire detectors and the accessing devices may be installed. Further, each of these fire detectors 108A-108D may be communicably connected with a fire control panel 112 through a network (not shown). The fire control panel 112 may be communicably connected with an access control database 116 through a network 114. In an exemplary embodiment, the fire control panel 112 may be communicably connected with the access control database 116 through a Wi-Fi network or a cellular network.

FIG. 1A depicts an exemplary scenario where a fire event may occur at the third floor near to the first room 104A. The plurality of fire detectors 108A-108D installed at the third floor may detect the fire event at the third floor. The plurality of fire detectors 108A-108D may sense fire/smoke using sensor/s in the third floor and report fire intensity readings to the fire control panel 112 through a network. The fire control panel 112 may then determine information related to the fire event. In an exemplary embodiment, the information related to the fire event may comprise fire intensity reading, a unique identifier of a fire detector 108, location of a fire detector 108 and/or a location of the fire event. In an exemplary embodiment, the location of the fire detectors 108 may be determined by using a global positioning system (GPS) or an indoor positioning system. In an alternative embodiment, the location information of the fire detectors 108 may be determined by using the unique identifier associated with a fire detector. It is to be noted that other ways or means of determining the location of the fire detectors 108 are covered with the scope of the present invention.

In order to determine the information related to the fire event, the fire control panel 112 may use the plurality of fire detectors 108A-108D, a location determining module, a processor to determine fire readings, a location of a fire detector 108, location of the fire event and a unique identifier of a fire detector 108 and a memory to store and information related to different parameters. Considering an exemplary Table 1 below showing the information related to the fire event determined by the fire control panel 112.

TABLE 1
Third Floor

| Unique | Readings of | |
|---|---|---|
| Identifier of | Fire (i.e. | |
| Fire Detector | Intensity) | Location of Fire Detector |
| 108A | 50 | Near to first room 104A |
| 108B | 40 | In front of second room 104B |
| 108C | 21 | In front of third room 104C |
| 108D | 10 | In front of fourth room 104D |

The intensity of fire may be measured in KW/m² unit. The values used in Table 1 and the specification are exemplary and any other modification in the values are within the scope of this invention. Although the exemplary Table 1 above shows fire intensity readings, unique identifier and location; however, other parameters such as temperature, smoke intensity and the like are within the scope of the invention.

In an exemplary embodiment, the fire control panel 112 may determine a location of the fire event. The location of the fire event may comprise location of a nearest fire detector of the fire event which has reported or sensed highest fire intensity reading. Considering the example in Table 1 above and based on the highest fire intensity reading, the location of the fire event may be determined by considering a location of the fire detector 108A which reported the highest fire intensity reading. Thereby, in this example, the location of the fire event may be determined as approximately “Near to first room 104A”. In addition, before transmitting the information related to the fire event to the access control database 116, the fire control panel 112 may confirm if the fire event has actually happened or not. Such confirmation can be done through the fire intensity readings reported by the fire detectors 108. In case, the fire control panel 112 is unable to confirm the fire event, then the fire control panel 112 may not transmit the information related to the fire event to the access control database 116.

On confirmation of the fire event, the fire control panel 112 may transmit the determined information related to the fire event to the access control database 116 through a network 114. In an exemplary embodiment, the fire control panel 112 may communicate directly with the access control database 116 through a short-range network (such as a Wi-Fi network or a bluetooth network) or a cellular network. The access control database 116 may receive the information from the fire control panel 112 and may determine one or more safe exit paths based on the information related to the fire event. For this, the access control database 116 may comprise a digitized map, information of entry and exit paths 110 and/or building architecture information (BMS related information), evacuation areas, images and fire displays of the premises 102. The access control database 116 may determine one or more safe exit paths by mapping the information related to the fire event (i.e. location of the fire event, the location of fire detectors, the fire intensity reading and the unique identifier) in the digitized map along with the information of entry and exit paths 110 of the premises 102 with respect to the location of the fire event.

The access control database 116 may use the mapped to the information on the digitized map and the information relative to the entry and exit paths 110 information to calculate a distance between the location of the fire event and a location of each of the plurality of exit paths 110A-110C for determining one or more safe exit path. The access control database 116 may prioritize each of the plurality of exit paths 110A-110C based on the calculated distance. Considering the same example as explained above where the access control database 116 determine the location of the fire event at “Near to first room 104A”. In this example, the access control database 116 may assign highest priority to the first exit path 110A since the distance between the location of the first exit path 110A and the location of the fire event is greater or maximum as compared to the other exit paths 110B/110C. Similarly, the access control database 116 may assign second highest priority to the second exit path 110B since the distance between the location of the first exit path 110A and the location of the fire event is greater or maximum as compared to the third exit path 110C. Thereby, the access control database 116 may determine the first exit path 110A and the second exit path 110B as one or more safe exit paths which is present (or located) near to the fourth room 104D and which is located away from the location of the fire event.

When the access control database 116 determines the one or more safe exit paths 110A/110B, the access control database 116 may transmit instructions to a mobile device 120 of the user 118 through a Wi-Fi network or a cellular network. The instructions may comprise the one or more safe exit paths 110A/110B and may be in the form of a signal or a command. Further, the user 118 may also be present at the third floor of the premises 102 as depicted in FIG. 1A. To guide the user 118 for exiting the preemies 102, the access control database 116 may transmit the instructions to the mobile device 120 of the user 118. When the mobile device 120 receives the instructions, the mobile device 120 may select a safe exit path (let's say 110A) from the one or more safe exit paths 110A/110B. The selection of the safe exit path may be done by choosing a safe exit path which has been assigned with highest priority as discussed above. In this case, the first exit path 110A has been assigned with highest priority and thus, the mobile device may choose the first exit path 110A as safe exit path over the second exit path 110B. Alternatively, a safe exit path may be selected which is near/close to the user 118 based on a location of the mobile device 120 of the user 118 and also safe to use or away from the location of the fire event. Further, the mobile device 120 may guide the user 118 through the safe exit path 110A using augmented reality through ultra-wide band (UWB). In an exemplary embodiment, a user application executed at the mobile device 120 may guide the user 118 of the mobile device 120 through the safe exit path 110A.

The user 118 may open the user application and then the user application may use an audio unit and a visual unit of the mobile device 120 to guide the user 118 of the mobile device 120 through the safe exit path 110A using augmented reality through ultra-wide band (UWB). In an exemplary embodiment, the visual unit of the mobile device 120 may be a camera and the audio unit may be a speaker of the mobile device 120. By using the audio unit of the mobile device 120, the mobile device 120 may provide voice commands for guidance. Such voice commands may be turn right, turn left, go straight or don't take right etc. Along with the voice guidance, the mobile device 120 uses the visual unit to provide visual stream of the premises 102 to the user 118 with directions such as turn right, turn left, go straight or don't take right. Such directions may be shown on an interface of the mobile device 120 to the user 118 through arrows, signs, textual messages etc. In particular, the direction/s may be superimposed (using the augmented reality) on the visual stream of the premises 102 to provide guidance of the safe exit path 110A to the user 118. In addition, the user 118 may simultaneously listen to the voice commands to exit the premises 102. In another embodiment of the present invention, the mobile device 120 may display the direction of the safe exit path 110A superimposed on the digitized map of the premise (instead of the visual stream from the camera) on the interface of the mobile device 120 using the augmented reality for guiding the user 118. Using the augmented reality for guiding the user 118 would be more accurate because this technique utilizes real-time data with the digitized map.

Furthermore, the mobile device 120 may also be capable of tracking/determining a location of the user 118 through the location of the mobile device 120. For tracking the location of the mobile device 120, each of the plurality of the accessing devices 106 may transmit a UWB signal to the mobile device 120 present at the third floor. In response, the mobile device 120 may transmit an acknowledgement signal to the plurality of the accessing devices 106. Then, the plurality of the accessing devices 106 may measure a time signal travels like a stop watch and then send a signal to the access control database 116. The plurality of the accessing devices 106 may also calculate a location of the mobile device 120 using the acknowledgement signal received from the mobile device 120. The access control database 116 may inform the user 118 about a safest exit path to the mobile device 120.

The mobile device 120 may determine if the user 118 is going in a correct direction to take the selected safe exit path 110A. In case the user 118 is going to an incorrect direction or taking an incorrect path (i.e. unsafe exit path), the mobile device 120 (via a user application) may provide instructions/guidance (such as the direction and voice command/s) of the safe exit path 110A to the user 118. Referring to an exemplary FIG. 1C, the user 118 can see the direction (using straight arrow along with a textual message “Fire exit gate”) on the mobile device 120 and listen to the voice command/s for guiding the user 118 of the mobile device 120 through the safe exit path 110A using the augmented reality. Here, the mobile device 120 has also determined that the user 118 is going in a correct direction to take the selected safe exit path 110A for exiting the premises 102. In FIG. 1D, the mobile device 120 is showing a direction as a message with “Don't go” along with a wrong sign as the mobile device 120 has determined that the user 118 is not going in a correct direction to take the selected safe exit path 110A. Using the ultra-wide band (UWB) enables ultra-precise localization. When the user 118 points the mobile device 120 to an incorrect exit gate of an unsafe exit path then, the mobile device 120 may show the direction as a message with “Don't go” along with a voice command based on the instructions from the access control database 116. When the user 118 turns the mobile device 120 to other side of the premises 102, then the mobile device 120 may show the direction as a message with “Go” with this exit path.

Referring back to FIG. 1A again, the present invention encompasses an exemplary alternative embodiment for transmitting the instructions comprising the one or more safe exit paths 110A/110B to the mobile device 120 via the plurality of the accessing devices 106. The access control database 116 may be communicably connected to the plurality of the accessing devices 106. When the access control database 116 determines the one or more safe exit paths 110A/110B, the access control database 116 may transmit the instructions related to the fire event in the premises 102 to the plurality of the accessing devices 106 through a network. On receiving the instructions, the plurality of the accessing devices 106 may automatically get open or unlocked so that users present inside each of the rooms 104A-10D can come outside.

Further, on receiving instructions related to the fire event from the access control database 116, each of the plurality of the accessing devices 106 may select a safe exit path 110A (with highest priority) from the one or more safe exit paths 110A/110B and also have a capability to show direction/s of the safe exit path 110A using color light. As depicted in FIG. 1A, each of the plurality of the accessing devices 106 is showing directions (using an arrow) towards left side as the safe exit path 110A is at the left side of the premises 102. The arrow showing directions towards left side is depicted in black color. However, the arrow can show directions using any color light. Any other forms of showing directions to the user 118 on the accessing devices 106 is also within the scope of the present invention. For this, each of the plurality of the accessing devices 106 may have an interface to show such directions. The user 118 can see and follow the directions shown using the color light to exit the premises 102. This would further guide the user 118 present inside the premises 102 to exit the premises 102 using the safe exit path 110A in case of the fire event.

In addition, the plurality of the accessing devices 106 may transmit the instructions to the mobile device 120 of the user 118 through a network. Accordingly, the mobile device 120 may further guide the user 118 using the augmented reality through the ultra-wide band technology to exit the premises 102 as described above. For this, the plurality of the accessing devices 106 may transmit their own location to the mobile device 120 via the network. Based on the location of the plurality of the accessing devices 106 received from the plurality of the accessing devices 106, the mobile device 120 may enable an audio unit as well as a visual unit of the mobile device 120 to start visual positioning guidance with the augmented reality technique to the user 118. Moreover, the plurality of the accessing devices 106 may further transmit the instructions to one or more digital fire direction boards installed in the premises 102 over a bluetooth mesh network so that these digital fire direction boards may also guide the user 118 to exit the premises 102 by showing directions using arrows and glowing the arrows with LED lights on the digital fire direction boards.

FIG. 1B depicts an exemplary system architecture 100B with fire event at a different location in a premises 102 according to an exemplary embodiment of the invention. As can be seen that a fire event may occur at the third floor and at the left side of the fourth room 104D. The plurality of fire detectors 108A-108D installed at the third floor may detect the fire event. Also, the plurality of fire detectors 108A-108D may sense fire/smoke using sensor/s in the third floor and report fire intensity readings to the fire control panel 112 through a network. The fire control panel 112 may then determine information related to the fire event. In an exemplary embodiment, the information related to the fire event may comprise fire intensity reading, a unique identifier of a fire detector 108, location of a fire detector 108 and/or a location of the fire event. Considering an exemplary Table 2 below showing the information related to the fire event determined by the fire control panel 112.

TABLE 2
Third Floor

| Unique | Readings of | |
|---|---|---|
| Identifier of | Fire (i.e. | |
| Fire Detector | Intensity) | Location of Fire Detector |
| 108A | 10 | Near to first room 104A |
| 108B | 21 | In front of second room 104B |
| 108C | 40 | In front of third room 104C |
| 108D | 50 | In front of fourth room 104D |

In an exemplary embodiment, the fire control panel 112 may determine a location of the fire event. The location of the fire event may comprise location of a nearest fire detector of the fire event which has reported or sensed highest fire intensity reading. Considering the example in Table 2 above and based on the highest fire intensity reading, the location of the fire event may be determined by considering a location of the fire detector 108D which reported the highest fire intensity reading. Thereby, in this example, the location of the fire event may be determined as approximately “In front of fourth room 104D”.

On confirmation of the fire event, the fire control panel 112 may transmit the determined information related to the fire event to the access control database 116 through a network. The access control database 116 may receive the information from the fire control panel 112 and may determine one or more safe exit paths based on the information related to the fire event. For this, the access control database 116 may determine one or more safe exit paths using the same methodology and techniques as explained in FIG. 1A above. Accordingly, the access control database 116 may calculate a distance between the location of the fire event and a location of each of the plurality of exit paths 110A-110C for determining one or more safe exit path.

Considering the same example as explained above where the access control database 116 determine the location of the fire event at “In front of fourth room 104D”. In this example, the access control database 116 may assign highest priority to the third exit path 110C since the distance between the location of the third exit path 110C and the location of the fire event is greater or maximum as compared to the other exit paths 110A/110B. Similarly, the access control database 116 may assign second highest priority to the second exit path 110B since the distance between the location of the second exit path 110B and the location of the fire event is greater or maximum as compared to the first exit path 110A. Thereby, the access control database 116 may determine the second exit path 110B and the third exit path 110C as one or more safe exit paths which is present (or located) near to the first room 104A and is located away from the location of the fire event.

After determining the one or more safe exit paths 110B/110C, the access control database 116 may transmit instructions to a mobile device 120 of the user 118. The instructions may comprise the one or more safe exit paths 110B/110C and may be in the form of a signal or a command. Further, the user 118 may also be present at the third floor of the premises 102 as depicted in FIG. 1B. When the mobile device 120 receives the instructions, the mobile device 120 may select a safe exit path (let's say 110C with highest priority as explained above) from the one or more safe exit paths 110B/110C and guide the user 118 through the safe exit path 110C using augmented reality in the same manner as explained in FIG. 1A above.

In the exemplary alternative embodiment, the instructions comprising the one or more safe exit paths 110B/110C to the mobile device 120 are transmitted via the plurality of the accessing devices 106. On receiving the instructions, the plurality of the accessing devices 106 may automatically get open or unlocked so that users present inside each of the rooms 104A-104D can come outside a room with corresponding accessing device. Further, on receiving the instructions related to the fire event from the access control database 116, each of the plurality of the accessing devices 106 may select a safe exit path 110C (with highest priority) from the one or more safe exit paths 110B/110C and may have a capability to show direction/s of the safe exit path 110C using color light. As depicted in FIG. 1B, each of the plurality of the accessing devices 106 is showing directions (using an arrow) towards right side as the safe exit path 110C is at the left side of the premises 102. The user 118 can see and follow the directions shown using color light to exit the premises 102. In addition, the plurality of the accessing devices 106 may transmit the instructions to the mobile device 120 of the user 118 so that the mobile device 120 may further guide the user 118 using the augmented reality to exit the premises 102 as described above in FIG. 1A.

The present invention also encompasses the plurality of accessing devices 106 to show direction of a safe exit path at one time and to show direction of another safe exit path at another time when there are more than one safe exit paths exist. This would provide more options to the user to exit the premises 102. It is also possible that some accessing devices 106 at a floor may show different directions than other accessing devices 106 at the same floor. It is within the scope of the present invention that the plurality of accessing devices 106 at one floor may show different directions of safe exit paths as compared to a plurality of accessing devices 106 at another floor. Such different directions may entirely depend on the location of the fire event and the location of each of the plurality of exit paths 110.

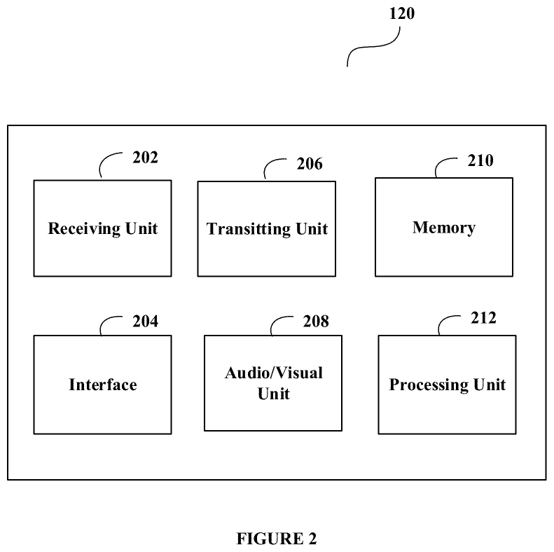

FIG. 2 depicts block diagram of different components of an exemplary mobile device 120 according to an exemplary embodiment of the invention. The mobile device 120 may comprise of, but is not limited to, a receiving unit 202, an interface 204, a transmitting unit 206, an audio/visual unit 208, a memory 210 and/or a processing unit 212. The receiving unit 202 may be configured to receive instructions related to a fire event inside a premises 102 from an access control database 116. In an alternative embodiment, the receiving unit 202 may be configured to receive instructions related to the fire event from a plurality of accessing devices 106. The access control database 116 may be configured to receive information related to the fire event from a fire control panel 112 and to determine the instructions related to the fire event based on the information related to the fire event. Also, the receiving unit 202 instructions comprise one or more safe exit paths. The receiving unit 202 may communicate the instructions to the processing unit 212. The processing unit 212 may be configured to select a safe exit path from the one or more safe exit paths 110 and may communicate the selected safe exit path to the audio/visual unit 208. Accordingly, the audio/visual unit 208 may be configured to guide a user 118 of the mobile device 120 through the safe exit path using augmented reality as described above in FIG. 1A. The interface 204 may be configured to be used by the audio/visual unit 208 to display directions or produce voice command to guide the user 118. The transmitting unit 206 may be configured to transmit any communication to the access control database 116 and/or the plurality of accessing devices 106. The memory 210 may be configured to store the instructions related to the fire event, the selected safe exit path/s and/or one or more user applications required to guide the user 118.

Moreover, the receiving unit 202, the interface 204, the transmitting unit 206, the audio/visual unit 208, and/or the memory 210 may be communicably coupled with the processing unit 212. The different units described herein are exemplary. The invention may be performed using one or more units. For example, the tasks executed by the receiving unit 202, the interface 204, the transmitting unit 206, the audio/visual unit 208, the memory 210 and/or the processing unit 212 may be performed by a single unit. Alternatively, more number of units as described herein may be used to perform the present invention.

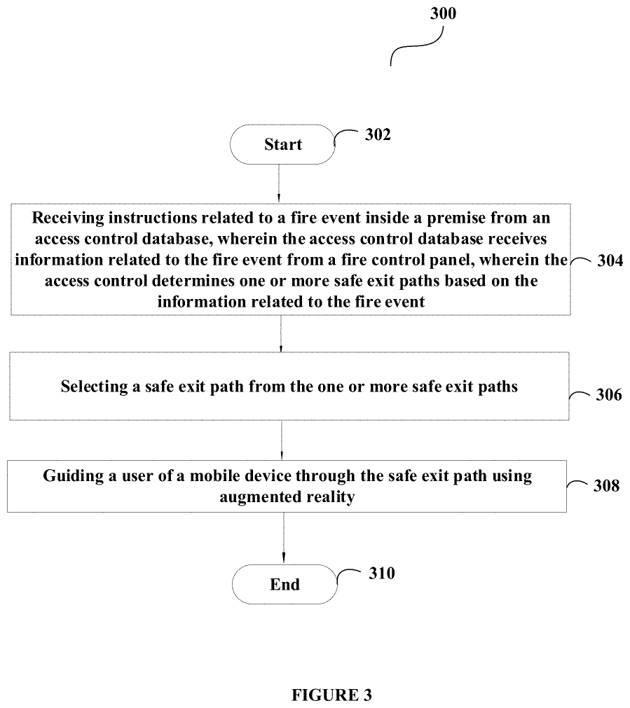

FIG. 3 depicts a flowchart outlining the features of the invention in an exemplary embodiment of the invention. The method flowchart 300 describes a method being for guiding a user through a safe exit path on an occurrence of a fire event in a premises. The method flowchart 300 starts at step 302.

At step 304, a mobile device 120 may receive instructions related to a fire event inside a premise 102 from an access control database 116. The access control database 116 may receive information related to the fire event from a fire control panel 112. Also, the access control 116 may determine one or more safe exit paths based on the information related to the fire event. This has been discussed in greater details in FIG. 1A and FIG. 1B.

At step 306, the mobile device 120 may select a safe exit path from the one or more safe exit paths 110. This has been discussed in greater details in FIG. 1A and FIG. 1B.

At step 308, the mobile device 120 may guide a user 118 of a mobile device 120 through the safe exit path using augmented reality. This has been discussed in greater details in FIG. 1A and FIG. 1B. Then, the method flowchart 300 may end at 310.

The present invention is applicable in various industries/fields such as, but not limited to, banking industry, hospitality industry, housing industry, building/construction industry, offices, universities, hospitals, colleges, homes and any such industry/field that is well known in the art and where fire may occur.

The embodiments of the invention discussed herein are exemplary and various modification and alterations to a person skilled in the art are within the scope of the invention.

In one embodiment of the invention, the invention can be operated using the one or more computer readable devices. The one or more computer readable devices can be associated with a mobile device 120. A computer readable medium comprises one or more processors and a memory coupled to the one or more processors, the memory stores instructions executed by the one or more processors. The one or more processors configured to receive instructions related to a fire event inside a premise 102 from an access control database 116. The access control database 116 receives information related to the fire event from a fire control panel 112. Also, the access control database 116 determines one or more safe exit paths based on the information related to the fire event. The one or more processors also configured to select a safe exit path from the one or more safe exit paths 110 and guide a user 118 of a mobile device 120 through the safe exit path using augmented reality.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” or “processing unit” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system comprising:
a fire control panel configured to detect a fire event inside a premise and transmit information related to the fire event;
an access control database configured to:
receive the information related to the fire event;
determine one or more safe exit paths based on the information related to the fire event; and
transmit instructions related to the fire event, wherein the instructions comprise the one or more safe exit paths; and
a mobile device configured to:
receive the instructions related to the fire event; and
select a safe exit path from the one or more safe exit paths and guide a user of the mobile device through the safe exit path using augmented reality.

2. The system of claim 1, wherein the fire control panel is configured to detect the fire event using one or more fire detectors installed inside the premise and confirm the fire event before transmitting the fire event information to the access control database.

3. The system of claim 2, wherein the fire event information is transmitted to the access control database using a Wi-Fi network, a cellular network or a bluetooth mesh network.

4. The system of claim 2, the fire event information comprises a location of the fire event and/or fire intensity of the fire event.

5. The system of claim 1, wherein the access control database comprises a digitized map and/or entry and exit paths information of the premises, wherein the access control database is configured to determine the one or more safe exit paths based on the fire event information using the digitized map and/or the entry and exit paths information of the premises.

6. The system of claim 1, wherein the mobile device is configured to execute a user application, wherein the user application is executed to guide the user of the mobile device through the safe exit path.

7. The system of claim 1, wherein the mobile device uses an audio unit and a visual unit of the mobile device to guide the user of the mobile device through the safe exit path using augmented reality.

8. The system of claim 1, wherein the access control database transmits the instructions related to the fire event to the mobile device through a Wi-Fi network, a cellular network or a bluetooth mesh network.

9. The system of claim 1, wherein the access control database is communicably connected to a plurality of accessing devices inside the premise, wherein in case of the fire event, the access control database transmits the instructions related to the fire event to the plurality of accessing devices, wherein each of the accessing devices open automatically on receiving the instructions.

10. The system of claim 9, wherein the mobile device is configured to receive the instructions related to the fire event from an accessing device of the plurality of accessing devices.

11. The system of claim 1, wherein the mobile device uses ultra-wide band technology to guide the user of the mobile device through the safe exit path, wherein the mobile device instructs the user using the ultra-wide band technology in case the user moves to an incorrect path.

12. The system of claim 9, wherein each of the plurality of accessing devices is configured to show direction of the safe exit path on receiving the instructions related to the fire event from the access control database.

13. A mobile device comprising:
a receiving unit configured to receive instructions related to a fire event inside a premises from an access control database, wherein the access control database is configured to receive information related to the fire event from a fire control panel and determine the instructions related to the fire event based on the information related to the fire event, wherein the instructions comprise one or more safe exit paths;
a processing unit configured to select a safe exit path from the one or more safe exit paths; and
an audio/visual unit configured to guide a user of the mobile device through the safe exit path using augmented reality.

14. The mobile device of claim 13, wherein the mobile device is configured to execute a user application, wherein the user application is executed to guide the user of the mobile device through the safe exit path.

15. The mobile device of claim 13, wherein the access control database is communicably connected to a plurality of accessing devices inside the premises, wherein in case of the fire event, the access control database transmits the instructions related to the fire event to the plurality of accessing devices, wherein the accessing devices open automatically on receiving the instructions.

16. The mobile device of claim 15, wherein the mobile device is configured to receive the instructions related to the fire event from an accessing device of the plurality of accessing devices.

17. The mobile device of claim 16, wherein the plurality of accessing devices are configured to show direction of the safe exit path on receiving the instructions related to the fire event from the access control database.

18. The mobile device of claim 1, wherein the mobile device uses ultra-wide band technology to guide the user of the mobile device through the safe exit path, wherein the mobile device instructs the user using the ultra-wide band technology in case the user moves to an incorrect path.

19. A method comprising:
receiving instructions related to a fire event inside a premise from an access control database, wherein the access control database receives information related to the fire event from a fire control panel, wherein the access control determines one or more safe exit paths based on the information related to the fire event;
selecting a safe exit path from the one or more safe exit paths; and
guiding a user of a mobile device through the safe exit path using augmented reality.

20. A computer readable medium comprising one or more processors and a memory coupled to the one or more processors, the memory storing instructions executed by the one or more processors, the one or more processors configured to:
receive instructions related to a fire event inside a premise from an access control database, wherein the access control database receives information related to the fire event from a fire control panel, wherein the access control database determines one or more safe exit paths based on the information related to the fire event;
select a safe exit path from the one or more safe exit paths; and
guide a user of a mobile device through the safe exit path using augmented reality.
